(19) United States
(12) Patent Application Publication
(10) Pub. No.: US 2011/0025666 A1
(43) Pub. Date: Feb. 3, 2011

(54) Temperature sensors of displays driver devices and display driver devices

(75) Inventors: Seung-Hwan Baek, Hwaseong-si (KR); Ji-Yong Jeong, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,428

(22) Filed: Apr. 16, 2010

(30) Foreign Application Priority Data
Jul. 28, 2009 (KR) 10-2009-0069046

(51) Int. Cl. G09G 5/00; G01K 7/00

(52) U.S. Cl. 345/211; 374/163; 374/E07.001

(57) ABSTRACT

A display driver device and a temperature sensor of a display driver device are provided. The temperature sensor includes a proportional voltage generating unit, and a sensing signal output unit. The proportional voltage generating unit generates a first proportional voltage, which is proportional to a temperature, and a second proportional voltage, which is inversely proportional to the temperature. The sensing signal output unit outputs a sensing signal by amplifying a voltage difference between the first and second proportional voltages. A sensing signal may vary linearly according to the temperature.

### PRIORITY STATEMENT

This nonprovisional U.S. application claims priority under 35 U.S.C. §119 to Korean Patent Application No. 10-2009-0069046, filed on Jul. 28, 2009, the entire contents of which are herein incorporated by reference.

### BACKGROUND

1. Field

Example embodiments relate to temperature sensors and display driver devices having the temperature sensors. Other example embodiments relate to a temperature sensor, which is capable of outputting a sensing signal that varies linearly in a wide range according to temperature, and a display driver device having the temperature sensor.

2. Description of Related Art

Most electronic devices are affected by temperature. That is, most electronic devices do not perform normal operations at excessively high or low temperatures. In order to make such an electronic device perform operations at an appropriate temperature, the electronic device detects its current temperature and performs operations according to the detected temperature. Accordingly, most electronic devices are equipped with temperature sensors in order to detect temperature.

Particularly, in order to drive a panel that functions to output images, a display driver device applies a high voltage to the panel, and thus operates at a high temperature. As the temperature is increased, current consumption is also increased, and the temperature of the display driver device is further increased. Furthermore, as a display device is gradually increased in size, the load of its display driver device is increased, and current consumption is increased. As a result, the temperature is further increased. The increase in temperature may cause the display driver device to malfunction.

### SUMMARY

Example embodiments provide a display driver device having a temperature sensor that is capable of outputting a sensing signal that varies linearly in a wide range according to temperature.

Example embodiments also provide a temperature sensor of a display driver device.

Example embodiments are directed to a display driver device. The display driver device includes a gate driver configured to drive a plurality of gate lines of a panel in response to a gate driver control signal, a source driver configured to receive digital data and drive a plurality of data lines of the panel in synchronization with a clock signal, and a controller configured to output the gate driver control signal and the digital data in response to image data and a command, and output the clock signal in response to a sensing signal. The source driver includes a temperature sensor configured to generate a first proportional voltage, which is proportional to temperature, and a second proportional voltage, which is inversely proportional to temperature, and output the sensing signal having a voltage level proportional to temperature, by amplifying the voltage difference between the first and second proportional voltages.

The temperature sensor may include a proportional voltage generating unit configured to generate and output the first and second proportional voltages, and a sensing signal output unit configured to output the sensing signal by detecting and amplifying the voltage difference between the first and second proportional voltages.

The proportional voltage generating unit may include a reference voltage generating unit connected between a first supply voltage and a second supply voltage, and configured to generate a reference voltage having a constant voltage level regardless of a change in temperature to first and second nodes, a first proportional voltage output unit connected in parallel with the reference voltage generating unit between the first supply voltage and the second supply voltage, and configured to output the first proportional voltage by mirroring and applying a current that flows to the second node to a first output node, and a second proportional voltage output unit connected in parallel with the reference voltage generating unit and the first proportional voltage output unit between the first supply voltage and the second supply voltage, and configured to output the second proportional voltage by mirroring and applying a current that flows to the second node to a second output node.

The first proportional voltage output unit may include a first transistor connected between the first supply voltage and the first output node, and having a gate connected to the second node, and an adjustment resistor connected between the first output node and the second supply voltage.

The second proportional voltage output unit may include a second transistor connected between the first supply voltage and the second output node, and having a gate connected to the second node, and at least one third transistor having an emitter terminal connected to the second output node, and base and collector terminals connected to the second supply voltage.

The sensing signal output unit may include a first amplification resistor connected between the first output node and a first input node, a second amplification resistor connected between the first input node and the second supply voltage, a third amplification resistor connected between the second output node and a second input node, a fourth resistor connected between the second input node and a sensing signal output node; and an amplifier configured to output the sensing signal to the sensing signal output node by detecting and amplifying the difference between voltages applied to the first and second input nodes.

The controller may adjust the pulse width of the clock signal in response to the sensing signal.

Other example embodiments are directed to a temperature sensor of a display driver device. The temperature sensor generates a first proportional voltage, which is proportional to temperature, and a second proportional voltage, which is inversely proportional to temperature, and outputs a sensing signal having a voltage level proportional to temperature, by amplifying the voltage difference between the first and second proportional voltages.

The temperature sensor may include a proportional voltage generating unit configured to generate and output the first and second proportional voltages, and a sensing signal output unit configured to output the sensing signal by detecting and amplifying the voltage difference between the first and second proportional voltages.

The proportional voltage generating unit may include a reference voltage generating unit connected between a first supply voltage and a second supply voltage, and configured to generate a reference voltage having a constant voltage level regardless of a change in temperature to first and second nodes, a first proportional voltage output unit connected in parallel with the reference voltage generating unit between the first supply voltage and the second supply voltage, and configured to output the first proportional voltage by mirroring and applying a current that flows to the second node to a first output node, and a second proportional voltage output unit connected in parallel with the reference voltage generating unit and the first proportional voltage output unit between the first supply voltage and the second supply voltage, and configured to output the second proportional voltage by mirroring and applying a current that flows to the second node to a second output node.

### BRIEF DESCRIPTION OF THE DRAWINGS

Example embodiments are described in further detail below with reference to the accompanying drawings. It should be understood that various aspects of the drawings may have been exaggerated for clarity.

FIG. 1 is a block diagram showing an example of a temperature sensor of a display driver device according to example embodiments;

FIG. 2 is a circuit diagram showing an example of a proportional voltage generating unit of FIG. 1;

FIG. 3 is a circuit diagram showing an example of a sensing signal output unit of FIG. 1;

FIG. 4 is a graph showing variations in first and second proportional voltages depending on variation in temperature;

FIG. 5 is a graph showing a variation in a sensing signal depending on variation in temperature; and

FIG. 6 is a block diagram showing an example of a display driver device having a temperature sensor according to example embodiments.

### DETAILED DESCRIPTION OF EXAMPLE EMBODIMENTS

Various example embodiments will now be described more fully with reference to the accompanying drawings in which some example embodiments are shown. In the drawings, the thicknesses of layers and regions may be exaggerated for clarity.

Detailed illustrative embodiments are disclosed herein. However, specific structural and functional details disclosed herein are merely representative for purposes of describing example embodiments. Inventive concepts, however, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the inventive concept. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, inventive concepts are not limited to example embodiments described.

A temperature sensor of a display driver device capable of outputting a sensing signal that varies linearly in a wide range according to temperature, and a display driver device having the temperature sensor will be described below with reference to the accompanying drawings.

FIG. 1 is a block diagram showing an example of a temperature sensor of a display driver device according to example embodiments.

Referring to FIG. 1, a temperature sensor 50 includes a proportional voltage generating unit 100 and a sensing signal output unit 200. The proportional voltage generating unit 100 detects a temperature, and outputs both a first proportional voltage Vptat, which increases in proportion to an increase in temperature, and a second proportional voltage Vctat, which decreases in inverse proportion to an increase in temperature. The sensing signal output unit 200 receives the first proportional voltage Vptat and the second proportional voltage Vctat, and outputs a sensing signal Vsen by amplifying the voltage difference between the two voltages.

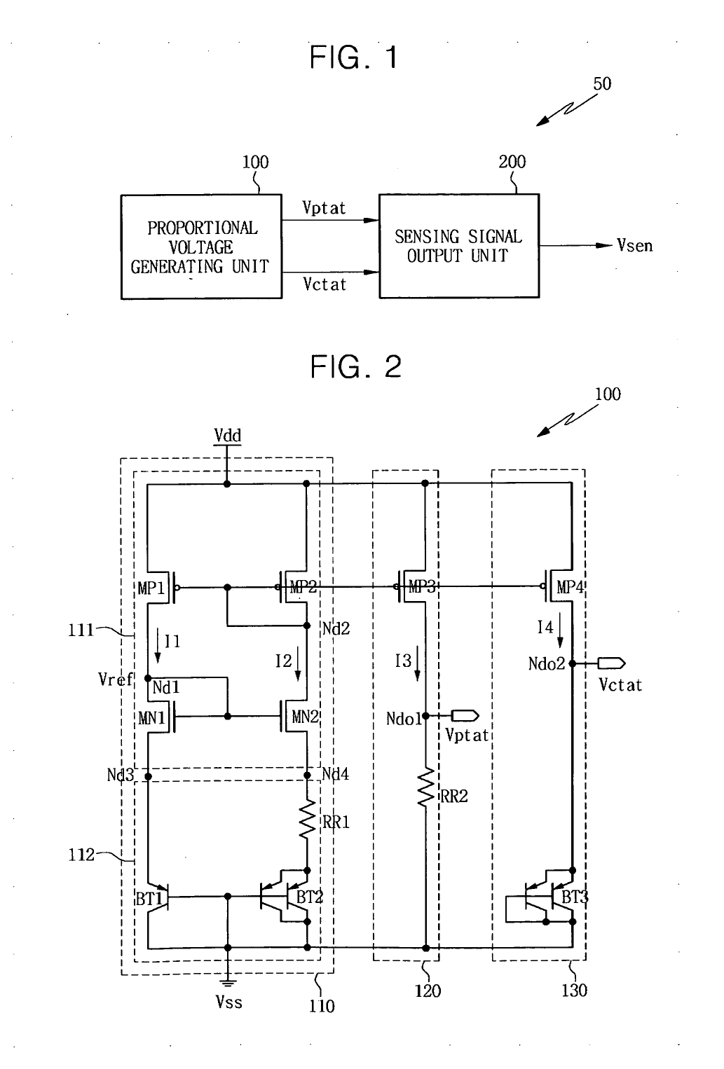

FIG. 2 is a circuit diagram showing an example of the proportional voltage generating unit of FIG. 1.

Referring to FIG. 2, the proportional voltage generating unit 100 includes a reference voltage generating unit 110, a first proportional voltage output unit 120 and a second proportional voltage output unit 130, which are connected in parallel between a first supply voltage Vdd and a second supply voltage Vss. The reference voltage generating unit 110 has the same configuration as a bandgap reference circuit, and includes a current mirror unit 111 and a level adjustment unit 112, which are connected between the first supply voltage Vdd and the second supply voltage Vss.

The current mirror unit 111 includes two current mirror circuits, and causes the same current to flow to first and third nodes Nd1 and Nd3 and to second and fourth nodes Nd2 and Nd4. The level adjustment unit 112 adjusts voltage levels of the first to fourth nodes Nd1 to Nd4 through the adjustment of the amount of current that flows to the first to fourth nodes Nd1 to Nd4. The current mirror unit 111 includes first and third transistors MP1 and MN1 connected in series between the first supply voltage Vdd and the third node Nd3, and second and fourth transistors MP2 and MN2 connected in series between the first supply voltage Vdd and the fourth node Nd4.

The current mirror unit 111 can be divided into a first current mirror circuit including the first and second transistors MP1 and MP2, and a second current mirror circuit including the third and fourth transistors MN1 and MN2. Gates of the first and second transistors MP1 and MP2 of the first current mirror circuit are connected in common to the second node Nd2 to which a drain of the second transistor MP2 is connected. Accordingly, the first and second transistors MP1 and MP2 mirror a second current I2 that flows through the second node Nd2. Consequently, a first current I1, which is proportional to the current that flows through the second node Nd2, flows to the first node Nd1. The first node Nd1 is connected to a drain of the first transistor MP1. Furthermore, gates of the third and fourth transistors MN1 and MN2 mirror the first current I1 that flows through the first node Nd1 to which a drain of the third transistor MN1 is connected, thus causing the second current I2, which is proportional to the current flowing through the third node Nd3, to flow to the fourth node Nd4. Accordingly, current that is proportional to the current flowing through the first and third nodes Nd1 and Nd3 flows through the second and fourth nodes Nd2 and Nd4. In this case, the second current I2 that flows through the second and fourth nodes Nd2 and Nd4 is determined by a ratio of the channel width W and channel length L of each of the second and fourth transistors MP2 and MN2 to the channel width W and channel length L of each of the first and third transistors MP1 and MN1. That is, when the “channel width W/channel length L” of each of the second and fourth transistors MP2 and MN2 is K times (where K is a positive real number) the “channel width W/channel length L” of each of the first and third transistors MP1 and MN1, the second current I2 is K times the first current I1.

When the “channel width W/channel length L” of the first transistor MP1 has the same value as that of the second transistor MP2 and the “channel width W/channel length L” of third transistor MN1 has the same value as that of the fourth transistor MN2, the amount of the first current I1 is the same as that of the second current I2. For convenience, descriptions are given below under the assumption that the amount of the first current I1 is the same as that of the second current I2. However, the second current I2 may be adjusted to be K times the first current I1 based on the “channel width W/channel length L” of each of the first to fourth transistors MP1, MP2, MN1 and MN2. Although, in the drawing, p-type metal oxide semiconductor (PMOS) transistors are used for the first and second transistors MP1 and MP2 and n-type metal oxide semiconductor (NMOS) transistors are used for the third and fourth transistors MN1 and MN2, different types of transistors may be used. Here, it should be noted that the first and second transistors MP1 and MP2 are the same type, and the third and fourth transistors MN1 and MN2 are the same type.

The current mirror unit 111 may not operate when both of the first and second currents I1 and I2 are 0 A at its initial operation. Accordingly, the current mirror unit 111 may additionally include a starting circuit for the initial operation of the current mirror unit 111. The starting circuit, which may be configured in various manners, is well-known, and thus a detailed description thereof is omitted.

Meanwhile, the level adjustment unit 112 includes a fifth transistor BT1, which is connected between the third node Nd3 and the second supply voltage Vss, and a level adjustment resistor RR1 and a sixth transistor BT2, which are connected in series between the fourth node Nd4 and the second supply voltage Vss. The level adjustment unit 112 determines the first and second currents I1 and I2 that flow through the third and fourth nodes Nd3 and Nd4, respectively, regardless of temperature, and performs adjustment so that the third and fourth node Nd3 and Nd4 have the same voltage level. The level adjustment resistor RR1 is used to determine the amount of current flowing through the fourth node Nd4 and the voltage level of the fourth node Nd4. The fifth and sixth transistors BT1 and BT2 are used to perform adjustment so that the voltage levels of the third and fourth nodes Nd3 and Nd4, respectively, are the same regardless of temperature. That is, the fifth and sixth transistors BT1 and BT2 have resistances that are inversely proportional to the temperature and thus, adjust the voltage levels of the third and fourth nodes Nd3 and Nd4 to be maintained at the same level regardless of temperature against the level adjustment resistor RR1 having a resistance that varies in proportion to temperature. When the current that flows to the fifth transistor BT1 is M times the current that flows to the sixth transistor BT2, the sixth transistor BT2 may be implemented to allow the current, which is M times the current flowing through the fifth transistor BT1, to flow through the sixth transistor BT2 such that the “channel width W/channel length L” of the sixth transistor BT2 becomes M times the “channel width W/channel length L” of the fifth transistor BT1. When M is a positive integer, the sixth transistor BT2 may be implemented in such a way that M transistors, each of which is the same as the fifth transistor BT1 are connected in parallel to each other.

As a result, the reference voltage generating unit 110 performs adjustment such that the first and second nodes Nd1 and Nd2 have the same reference voltage (Vref) level regardless of temperature.

Meanwhile, the first proportional voltage output unit 120 includes a seventh transistor MP3 and an adjustment resistor RR2, which are connected in series between the first supply voltage Vdd and the second supply voltage Vss. The seventh transistor MP3 is connected between the first supply voltage Vdd and a first output node Ndo1 that outputs the first proportional voltage Vptat that is proportional to temperature. A gate of the seventh transistor MP3 is connected to the second node Nd2. Accordingly, the reference voltage Vref, which is the same as applied to the gate of the second transistor MP2, is applied to the gate of the seventh transistor MP3. The seventh transistor MP3 and the second transistor MP2 form a current mirror. When the “channel width W/channel length L” of the seventh transistor MP3 has the same value as the “channel width W/channel length L” of the second transistor MP2, the current mirror causes the current, which is the same as that flowing to the fourth node Nd4, to flow to the first output node Ndo1.

The resistance of the adjustment resistor RR2 connected between the first output node Ndo1 and the second supply voltage Vss is proportional to temperature. Accordingly, the first proportional voltage Vptat that is output from the first output node Ndo1 varies in proportion to temperature. Here, the first proportional voltage Vptat may vary depending on a ratio of the adjustment resistor RR2 to the level adjustment resistor RR1 according to a change in temperature. That is, the rate of change of the first proportional voltage Vptat according to a change in temperature may be adjusted through the adjustment of the resistances of the level adjustment resistor RR1 and the adjustment resistor RR2.

The second proportional voltage output unit 130 includes an eighth transistor MP4 and a ninth transistor BT3, which are connected in series between the first supply voltage Vdd and the second supply voltage Vss. The eighth transistor MP4 is connected between the first supply voltage Vdd and a second output node Ndo2 that outputs the second proportional voltage Vctat that is inversely proportional to temperature. A gate of the eighth transistor MP4 is connected to the second node Nd2. Accordingly, the voltage, which is the same as applied to the gate of the second transistor MP2, is applied to the gate of the eighth transistor MP4. The eighth transistor MP4 and the second transistor MP2 form a current mirror. The current mirror causes the same current as that flowing to the second node Nd2 to flow to the second output node Ndo2 by mirroring the current that flows to the second node Nd2.

The resistance of the ninth transistor BT3 is inversely proportional to temperature. Accordingly, the level of the second proportional voltage Vctat that is output from the second output node Ndo2 is inversely proportional to temperature. Here, the rate of change of the second proportional voltage Vctat according to temperature is determined by a ratio of the current that flows through the ninth transistor BT3 to the current that flows through the sixth transistor BT2. Accordingly, the rate of change of the second proportional voltage Vctat according to temperature can be adjusted by a ratio of the “channel width W/channel length L” of the ninth transistor BT3 to the “channel width W/channel length L” of the sixth transistor BT2. When each of the sixth and ninth transistors BT2 and BT3 is implemented using one or more identical transistors, the rate of change of the second proportional voltage Vctat may be adjusted by a ratio of the number of the ninth transistors BT3 to the number of the sixth transistors BT2. In particular, the second proportional voltage Vctat, which varies in inverse proportion to a change in temperature, is also determined by a ratio of the current that flows to the ninth transistor BT3 to the current that flows to the sixth transistor BT2 so that it can be varied linearly.

As described above, the proportional voltage generating unit 100 of FIG. 2 may adjust the rate of change of the first proportional voltage Vptat according to temperature through the adjustment of the resistances of the level adjustment resistor RR1 and the adjustment resistor RR2, and may adjust the rate of change of the second proportional voltage Vctat through the adjustment of the sixth transistor BT2 and the ninth transistor BT3.

It is assumed above that the seventh and eighth transistors MP3 and MP4 have the same “channel width W/channel length L” as the first and second transistors MP1 and MP2, respectively, but the seventh and eighth transistors MP3 and MP4 may have “channel width W/channel length L” different than the first or second transistor MP1 or MP2, respectively.

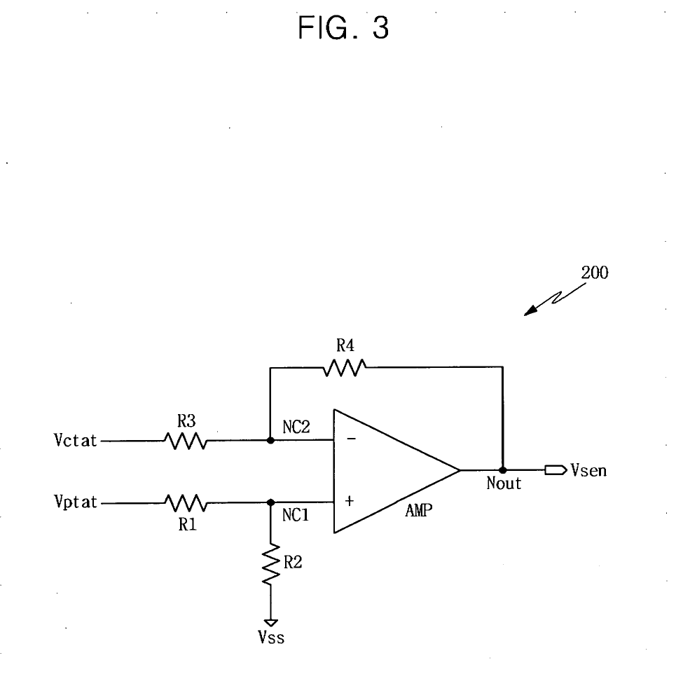

FIG. 3 is a circuit diagram showing an example of the sensing signal output unit of FIG. 1.

The sensing signal output unit 200 includes an amplifier AMP for amplifying the voltage difference between the first proportional voltage Vptat and the second proportional voltage Vctat and outputting the sensing signal Vsen, and first to fourth amplification resistors R1 to R4 for adjusting the amplification rate of the sensing signal Vsen. The first amplification resistor R1 is connected between the first output node Ndo1 of the proportional voltage generating unit 100 and a first input node NC1 that is connected to one input terminal of the amplifier AMP. The second amplification resistor R2 is connected between the first input node NC1 and the second supply voltage Vss. The third amplification resistor R3 is connected between the second output node Ndo2 of the proportional voltage generating unit 100 and a second input node NC2 that is connected to the other input terminal of the amplifier AMP. The fourth amplification resistor R4 is connected between the second input node NC2 and a sensing signal output node N out of the amplifier AMP. The sensing signal output unit 200 has the configuration of a subtractor.

The first and second output nodes Ndo1 and Ndo2 of the proportional voltage generating unit 100 output the first proportional voltage Vptat and the second proportional voltage Vctat, respectively.

Accordingly, when the first and third amplification resistors R1 and R3 have the same resistance and the second and fourth amplification resistors R2 and R4 have the same resistance, the voltage level of the sensing signal Vsen that is output from the sensing signal output unit 200 is expressed by the following Equation 1.

$$\frac{R 2}{R 1} \times ( Vptat - Vctat ) \qquad ( 1 )$$

That is, the voltage level of the sensing signal Vsen is obtained by multiplying the voltage difference between the first proportional voltage Vptat and the second proportional voltage Vctat by a ratio of the second amplification resistors R2 to the first amplification resistors R1.

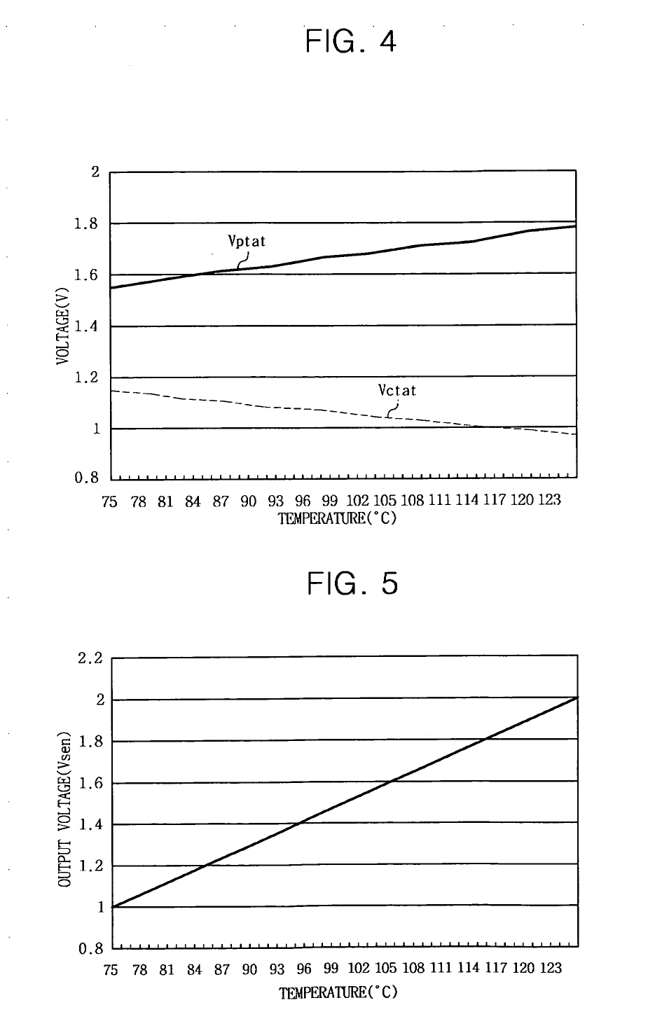

FIG. 4 is a graph showing variation in first and second proportional voltages depending on variation in temperature.

As shown in FIG. 4, the first proportional voltage Vptat, which is output by the proportional voltage generating unit 100 of FIG. 2, varies in proportion to temperature, while the second proportional voltage Vctat, which is output by the proportional voltage generating unit 100 of FIG. 2, varies in inverse proportion to temperature. Also, the rate of change of the first proportional voltage Vptat according to temperature can be adjusted through the adjustment of the resistances of the level adjustment resistor RR1 and of the adjustment resistors RR2, and the rate of change of the second proportional voltage Vctat according to temperature can be adjusted through the adjustment of the sixth transistor BT2 and the ninth transistor BT3. Furthermore, both the first and second proportional voltages Vptat and Vctat vary linearly according to a change in temperature.

For convenience, the first and third amplification resistors R1 and R3 have been described as having the same resistances as the second and fourth amplification resistors R2 and R4, but example embodiments are not limited to this case. For example, the first to fourth resistors R1 to R4 may have resistances different from each other.

FIG. 5 is a graph showing variation in a sensing signal depending on variation in temperature.

Referring to FIGS. 3 and 4, the voltage level of the sensing signal Vsen is determined by multiplying the voltage difference between the first proportional voltage Vptat and the second proportional voltage Vctat by a ratio of the second amplification resistor R2 to the first amplification resistor R1. As shown in FIG. 4, the level of the first proportional voltage Vptat increases linearly in proportion to an increase in temperature, while the level of the second proportional voltage Vctat decreases linearly in inverse proportion to an increase in temperature. Accordingly, when the temperature increases, the voltage difference between the first and second proportional voltages Vptat and Vctat increases linearly. As a result, when the temperature sensor 50 of FIG. 1 is used to measure temperature, rather than a temperature sensor using only a voltage that is proportional to a change in temperature or a temperature sensor using only a voltage that is inversely proportional to a change in temperature, the voltage level of the sensing signal Vsen can be greatly varied according to a change in temperature. Also, the sensing signal Vsen varies linearly according to a change in temperature.

The maximum and minimum voltage levels of the sensing signal Vsen may be determined within a predetermined temperature range through the adjustment of the resistances of the first and second amplification resistors R1 and R2. That is, the rate of change of the sensing signal Vsen according to a change in temperature may be adjusted using the resistances of the first and second amplification resistors R1 and R2.

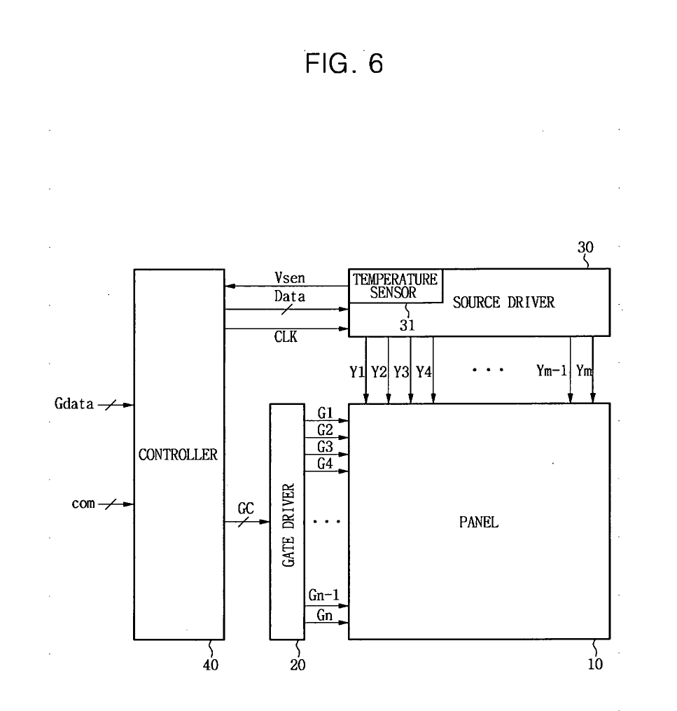

FIG. 6 is a block diagram showing an example of a display driver device having a temperature sensor according to example embodiments.

Referring to FIG. 6, the display driver device includes a panel 10, a gate driver 20, a source driver 30, and a controlled 40.

The panel 10 includes a plurality of gate lines disposed in a row direction, a plurality of data lines disposed in a column direction, and a plurality of pixel electrodes disposed between the plurality of gate lines and the plurality of data lines.

The gate driver 20 applies gate ON voltages G1 to Gn to the gate lines of the panel 10 in response to a gate driver control signal GC received from the controller 40.

The source driver 30 receives a clock signal CLK along with digital data Data from the controller 40, and generates display data voltages Y1 to Ym that correspond to the digital data Data. And, the source driver 30 outputs the respective display data voltages Y1 to Ym to the data lines of the panel 10 in synchronization with the clock signal CLK. Also, a temperature sensor 31 of the source driver 30 detects a current operation temperature of the source driver 30, and outputs a sensing signal Vsen to the controller 40. The temperature sensor 31 may be the temperature sensor 50, shown in FIG. 1.

The controller 40 outputs the gate driver control signal GC to the gate driver 20 in response to image data Gdata and a command corn received from the outside and the sensing signal Vsen received from the temperature sensor 31 of the source driver 30, and also outputs the digital data Data and the clock signal CLK to the source driver 30. Here, the controller 40 detects an operation temperature of the source driver 30 through the detection of a voltage level of the sensing signal Vsen received from the temperature sensor 31 of the source driver 30, and outputs the clock signal CLK whose pulse width is adjusted when the operation temperature of the source driver 30 is lower or higher than a temperature.

The source driver 30 generates the display data voltages Y1 to Ym. The display data voltages Y1 to Ym fall in, for example, a large voltage range of 0 to 15 V. The source driver 30 drives the data lines of the panel 10 using the display data voltages Y1 to Ym, thus generating a large amount of heat. Generally, the source driver 30 operates in a temperature range of 75° C. to 125° C. or above. Accordingly, in order to accurately direct a wide operation temperature range, the voltage level of the sensing signal Vsen output by the temperature sensor 31 must vary linearly and in a wide voltage range according to a change in temperature. In response to the sensing signal Vsen, the controller 40 adjusts the pulse width of the clock signal CLK to control the operation speed of the source driver 30, or adjusts the levels of the display data voltages Y1 to Ym to fall within a predetermined range and lower the operation temperature of the source driver 30.

However, the source driver 30 operates at a high operation temperature and in a wide operational temperature range, while the controller 40 generally operates at a low voltage of 3 V or less. Accordingly, the controller 40 may easily detect a voltage that varies within a range of 0 to 3 V, but has a difficulty in detecting a voltage exceeding the range. Furthermore, even for a voltage within the range, a certain level of margin is used. Accordingly, when the sensing signal Vsen output from the temperature sensor 31 is set to have a voltage level of 1 to 2 V in a temperature range of 75° C. to 125° C., the controller 40 may detect a change in temperature at a high resolution, and cope with noises due to the margin.

As a result, the display driver device according to example embodiments includes the temperature sensor that generates the first proportional voltage, which is proportional to temperature, and the second proportional voltage, which is inversely proportional to temperature, and outputs the sensing signal Vsen, which varies linearly according to temperature and in a wide voltage range, by amplifying the voltage difference between the first and second proportional voltages. Accordingly, it is possible to detect an accurate temperature, and thus malfunctions can be reduced.

Although the description has been made above that the source driver 30 operates in a temperature range of 75° C. to 125° C., the controller 40 operates at a voltage of 3 V, and the sensing signal Vsen is output in a voltage range of 0 to 3 V, these conditions are only one example and may be modified in various ways.

In the temperature sensor and the display driver device having the temperature sensor according to example embodiments, a sensing signal can vary linearly in a wide range because the temperature sensor generates the first proportional voltage, which is proportional to temperature, and the second proportional voltage, which is inversely proportional to temperature, and outputs the sensing signal by amplifying the voltage difference between the first and second proportional voltages. Accordingly, the controller of the display driver device can detect accurate temperature, and thus the operation of the display driver device depending on temperature can be easily controlled.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of inventive concepts as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

1. A display driver device, comprising:
a gate driver configured to drive a plurality of gate lines of a panel in response to a gate driver control signal;
a source driver configured to drive a plurality of data lines of the panel based on a clock signal; and
a controller configured to output the gate driver control signal in response to image data and a command, and output the clock signal in response to a sensing signal,
wherein the source driver includes a temperature sensor configured to generate a first proportional voltage, which is proportional to a temperature of the source driver, and a second proportional voltage, which is inversely proportional to the temperature, and the temperature sensor configured to output the sensing signal based on the first and second proportional voltages.

2. The display driver device according to claim 1, wherein the source driver is configured to output the sensing signal based on an amplified voltage difference between the first and second proportional voltages.

3. The display driver device according to claim 1, wherein the temperature sensor comprises:
a proportional voltage generating unit configured to generate and output the first and second proportional voltages based on the temperature of the source driver; and
a sensing signal output unit configured to output the sensing signal based on the first and second proportional voltages.

4. The display driver device of claim 3, wherein the sensing signal output unit is configured to output the sensing signal based on an amplified voltage difference between the first and second proportional voltages.

5. The display driver device according to claim 3, wherein the proportional voltage generating unit comprises:
a reference voltage generating unit connected between a first supply voltage and a second supply voltage, the reference voltage generating unit having first and second nodes and configured to generate a reference voltage;
a first proportional voltage output unit connected between the first supply voltage and the second supply voltage and in parallel with the reference voltage generating unit, the first proportional voltage output unit being configured to output the first proportional voltage at a first output node by mirroring a current at the second node; and
a second proportional voltage output unit connected between the first supply voltage and the second supply voltage and in parallel with the reference voltage generating unit and the first proportional voltage output unit, the second proportional voltage output unit being configured to output the second proportional voltage at a second output node by mirroring the current at the second node.

6. The display driver device of claim 5, wherein the reference voltage generating unit is configured to output the reference voltage at a constant voltage level.

7. The display driver device according to claim 5, wherein the first proportional voltage output unit comprises:
a first transistor connected between the first supply voltage and the first output node, a gate of the first transistor being connected to the second node; and
an adjustment resistor connected between the first output node and the second supply voltage.

8. The display driver device according to claim 7, wherein the second proportional voltage output unit comprises:
a second transistor connected between the first supply voltage and the second output node, a gate of the second transistor connected to the second node; and
at least one third transistor having an emitter terminal connected to the second output node, and base and collector terminals connected to the second supply voltage.

9. The display driver device according to claim 5, wherein the sensing signal output unit comprises:
a first amplification resistor connected between the first output node and a first input node;
a second amplification resistor connected between the first input node and the second supply voltage;
a third amplification resistor connected between the second output node and a second input node;
a fourth resistor connected between the second input node and a sensing signal output node; and
an amplifier configured to output the sensing signal to the sensing signal output node by amplifying a difference between voltages applied to the first and second input nodes.

10. The display driver device according to claim 1, wherein the controller is configured to adjust a pulse width of the clock signal in response to the sensing signal.

11. A temperature sensor comprising:
a proportional voltage generating unit configured to generate and output first and second proportional voltages, the first proportional voltage being proportional to a temperature, and the second proportional voltage being inversely proportional to the temperature, and the temperature sensor being configured to output a sensing signal having a voltage level proportional to the temperature by amplifying a voltage difference between the first and second proportional voltages.

12. The temperature sensor according to claim 11, further comprising:
a sensing signal output unit configured to output the sensing signal by detecting and amplifying the voltage difference between the first and second proportional voltages.

13. The temperature sensor according to claim 12, wherein the proportional voltage generating unit comprises:
a reference voltage generating unit connected between a first supply voltage and a second supply voltage, the reference voltage generating unit having first and second nodes and configured to generate a reference voltage;
a first proportional voltage output unit connected between the first supply voltage and the second supply voltage and in parallel with the reference voltage generating unit, the first proportional voltage output unit being configured to output the first proportional voltage at a first output node by mirroring a current at the second node; and
a second proportional voltage output unit connected between the first supply voltage and the second supply voltage and in parallel with the reference voltage generating unit and the first proportional voltage output unit, the second proportional voltage output unit being configured to output the second proportional voltage at a second output node by mirroring the current at the second node.

14. The temperature sensor of claim 13, wherein the reference voltage generating unit is configured to output the reference voltage at a constant voltage level.

15. The temperature sensor of claim 13, wherein the first proportional voltage output unit comprises:
a first transistor connected between the first supply voltage and the first output node, a gate of the first transistor being connected to the second node; and
an adjustment resistor connected between the first output node and the second supply voltage.

16. The temperature sensor of claim 15, wherein the second proportional voltage output unit comprises:
a second transistor connected between the first supply voltage and the second output node, a gate of the second transistor connected to the second node; and
at least one third transistor having an emitter terminal connected to the second output node, and base and collector terminals connected to the second supply voltage.
